(19) United States
(12) Patent Application Publication
(10) Pub. No.: US 2013/0219908 A1
(43) Pub. Date: Aug. 29, 2013

(54) GEARED TURBOFAN ARCHITECTURE FOR IMPROVED THRUST DENSITY

(71) Applicants: Frederick M. Schwarz, Glastonbury, CT (US); Daniel Bernard Kupratis, Wallingford, CT (US); Gabriel L. Suciu, Glastonbury, CT (US)

(72) Inventors: Frederick M. Schwarz, Glastonbury, CT (US); Daniel Bernard Kupratis, Wallingford, CT (US); Gabriel L. Suciu, Glastonbury, CT (US)

(21) Appl. No.: 13/483,406

(22) Filed: May 30, 2012

Related U.S. Application Data
(63) Continuation of application No. 13/408,109, filed on Feb. 29, 2012.

(51) Int. Cl. F02C 3/10

(52) U.S. Cl. 60/774; 60/792

(57) ABSTRACT

A turbine engine includes a fan, a compressor section having a low pressure compressor section and a high pressure compressor section, a combustor in fluid communication with the compressor section and a turbine section in fluid communication with the combustor. The turbine section includes a low pressure turbine section and a high pressure turbine section. The low pressure compressor section, the low pressure turbine section and the fan rotate in a first direction whereas the high pressure compressor section and the high pressure turbine section rotate in a second direction opposite the first direction.

### CROSS-REFERENCE TO RELATED APPLICATION

This application is a continuation of U.S. application Ser. No. 13/408,109 filed Feb. 29, 2012.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an inner shaft to form a high spool, and the low pressure turbine drives the low pressure compressor through an outer shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds. In these geared embodiments, the fan is driven to rotate with the high pressure compressor and the high pressure turbine in a direction opposite to the direction in which the low pressure compressor and low pressure turbine rotate.

Although geared architectures have improved propulsive efficiency, turbine engine manufacturers continue to seek further improvements to propulsive efficiency. One theoretical way in which to improve propulsive efficiency is to improve a turbine engine's power density.

### SUMMARY

A gas turbine engine according to an exemplary embodiment of this disclosure, among other possible things includes a fan rotatable about an axis, a compressor section having a low pressure compressor section and a high pressure compressor section, a combustor in fluid communication with the compressor section, a turbine section in fluid communication with the combustor, the turbine section having a low pressure turbine section and a high pressure turbine section and a speed change system driven by the turbine section. The fan is driven in a first direction by the turbine section through the speed change system, the low pressure compressor section and the low pressure turbine section rotate about the axis in the first direction, and the high pressure compressor section and the high pressure turbine section rotate about the axis in a second direction opposite the first direction.

In a further embodiment of the foregoing, a power density of greater than about 1.5 lbf/in³ and less than or equal to about 5.5 lbf/in³.

In a further embodiment of any of the foregoing, the speed change system comprises a geared architecture.

In a further embodiment of any of the foregoing, the geared architecture is a planetary geared architecture.

In a further embodiment of any of the foregoing, the planetary geared architecture includes, a sun gear driven by the turbine section, a plurality of planetary gears driven by the sun gear, a carrier supporting each of the plurality of planetary gears and a ring gear, and wherein the fan is attached to the carrier for rotation in the first direction.

In a further embodiment of any of the foregoing, the low pressure turbine section drives a first shaft, which drives the sun gear.

In a further embodiment of any of the foregoing, including a mid-turbine frame between the low pressure turbine section and the high pressure turbine section, wherein the mid-turbine frame comprises a fixed vane.

In a further embodiment of any of the foregoing, the fixed vane of the mid-turbine frame comprises a plurality of airfoils operable to direct airflow entering the low pressure turbine section.

In a further embodiment of any of the foregoing, the mid-turbine frame includes a strut for supporting a bearing supporting rotation of a portion of the turbine section.

In a further embodiment of any of the foregoing, the fixed vane comprises an inlet vane for the low pressure turbine section.

In a further embodiment of any of the foregoing, the high pressure turbine section includes two stages.

In a further embodiment of any of the foregoing, the high pressure turbine section includes a single stage.

In a further embodiment of any of the foregoing, the low pressure turbine section includes at least one powdered metal disc.

In a further embodiment of any of the foregoing, the low pressure turbine section includes at least one stage comprising single crystal turbine blades.

In a further embodiment of any of the foregoing, the low pressure turbine section includes at least one stage comprising directionally solidified turbine blades.

In a further embodiment of any of the foregoing, the low pressure turbine section is at least partially constructed of an aluminum lithium material.

A method for increasing a power density of a gas turbine engine according to an exemplary embodiment of this disclosure, among other possible things includes rotating a low pressure turbine section and a low pressure compressor section in a first direction, rotating a high pressure turbine section and a high pressure compressor section in a second direction opposite the first direction, and driving a fan through a speed change system in the first direction such that the low pressure turbine section and low pressure compressor section rotate at a speed greater than the fan.

In a further embodiment of the foregoing, including the step of reducing a volume of the low pressure turbine section by directing high speed gas flow entering the low pressure turbine section with a mid-turbine frame vane.

In a further embodiment of any of the foregoing, including housing a mid-turbine frame strut within the mid-turbine frame vane.

In a further embodiment of any of the foregoing, including generating a power density that is greater than or equal to about 1.5 lbf/in³ and less than or equal to about 5.5 lbf/in³.

Although the different examples have the specific components shown in the illustrations, embodiments of this invention are not limited to those particular combinations. It is possible to use some of the components or features from one of the examples in combination with features or components from another one of the examples.

These and other features of the present invention can be best understood from the following specification and drawings, the following of which is a brief description.

These and other features of the present invention can be best understood from the following specification and drawings, the following of which is a brief description.

### BRIEF DESCRIPTION OF THE DRAWINGS

FIG. 1 schematically shows an embodiment of a gas turbine engine.

FIG. 2 schematically shows rotational features of the engine embodiment shown in FIG. 1.

FIG. 3 schematically illustrates a turbine section of the engine embodiment shown in FIGS. 1 and 2.

### DETAILED DESCRIPTION

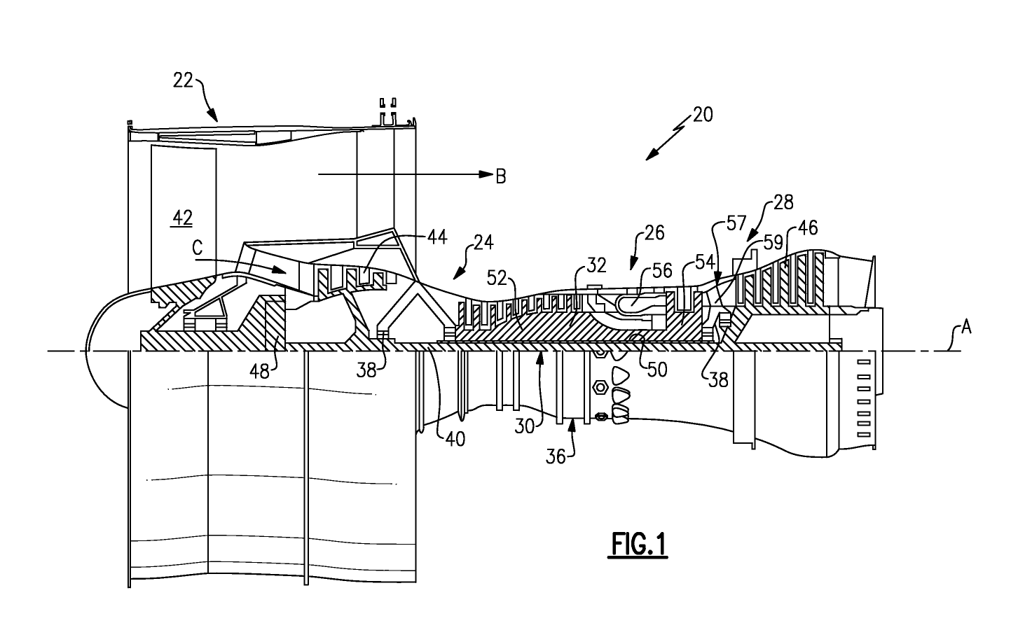

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. A combustor 56 is arranged between the high pressure compressor 52 and the high pressure turbine 54. In one example, the high pressure turbine 54 includes at least two stages to provide a double stage high pressure turbine. In another example, the high pressure turbine 54 includes only a single stage. As used herein, a “high pressure” compressor or turbine experiences a higher pressure than a corresponding “low pressure” compressor or turbine.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46. The inner shaft 40 and the outer shaft 50 are concentric and rotate via the bearing systems 38 about the engine central longitudinal axis A.

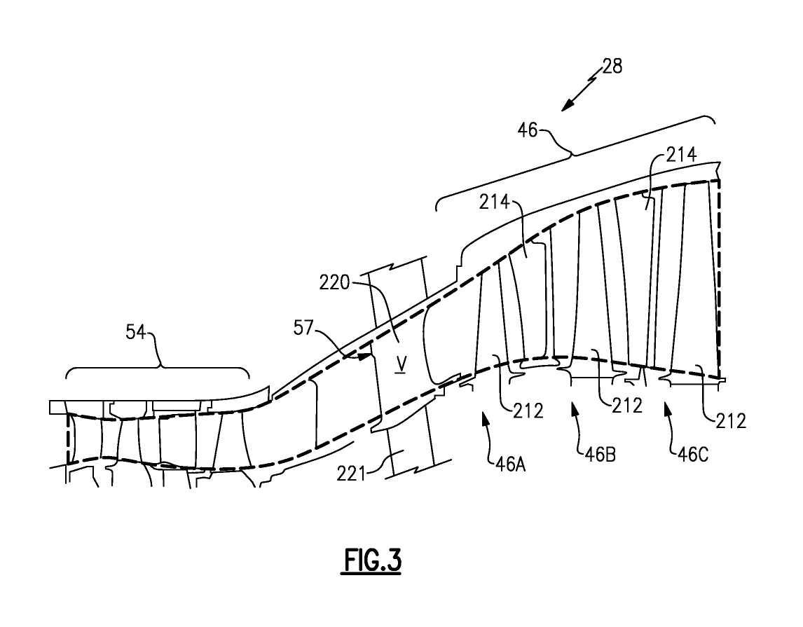

The core airflow C is compressed by the low pressure compressor 44 then the high pressure compressor 52, mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the length of the mid-turbine frame 57, and allows vanes upstream of a first low pressure turbine blade 212 (shown in FIG. 3) to be omitted. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

The example low pressure turbine 46 has a pressure ratio that is greater than about 5. The pressure ratio of the example low pressure turbine 46 is measured prior to an inlet of low pressure turbine 46 as related to the pressure measured at the outlet of the low pressure turbine 46 prior to an exhaust nozzle.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel per hour being burned divided by lbf of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.45.

“Low corrected fan tip speed” is the actual fan tip speed in ft/sec divided by an industry standard temperature correction of [(Tram deg R)/518.7)^{0.5}]. The “Low corrected fan tip speed” as disclosed herein according to one non-limiting embodiment is less than about 1150 ft/second.

The amount of thrust that can be produced by a particular turbine section compared to how compact the turbine section is, is referred to as the power density of the turbine section, and is derived by the flat-rated Sea Level Take-Off (SLTO) thrust divided by the volume of the entire turbine section. The example volume is determined from an inlet of the high pressure turbine 54 to an exit of the low pressure turbine 46. In order to increase the power density of the turbine section 28, each of the low pressure and high pressure turbines 46, 54 is made more compact. That is, the high pressure turbine 54 and the low pressure turbine 46 are made with a shorter axial length, and the spacing between each of the turbines 46, 54 is decreased, thereby decreasing the volume of the turbine section 28.

The power density in the disclosed gas turbine engine 20 including the gear driven fan section 22 is greater than those provided in prior art gas turbine engine including a gear driven fan. Eight disclosed exemplary engines, which incorporate turbine sections and fan sections driven through a reduction gear system and architectures as set forth in this application, are described in Table I as follows:

TABLE 1

| | | Turbine | Thrust/turbine |
|---|---|---|---|
| | Thrust SLTO | section volume | section volume |
| Engine | (lbf) | from the Inlet | (lbf/in³) |
| 1 | 17,000 | 3,859 | 4.4 |
| 2 | 23,300 | 5,330 | 4.37 |
| 3 | 29,500 | 6,745 | 4.37 |
| 4 | 33,000 | 6,745 | 4.84 |
| 5 | 96,500 | 31,086 | 3.1 |
| 6 | 96,500 | 62,172 | 1.55 |
| 7 | 96,500 | 46,629 | 2.07 |
| 8 | 37,098 | 6,745 | 5.50 |

In some embodiments, the power density is greater than or equal to about 1.5 lbf/in³. In further embodiments, the power density is greater than or equal to about 2.0 lbf/in³. In further embodiments, the power density is greater than or equal to about 3.0 lbf/in³. In further embodiments, the power density is greater than or equal to about 4.0 lbf/in³. In further embodiments, the power density is less than or equal to about 5.5 lbf/in³.

Engines made with the disclosed gear driven fan architecture, and including turbine sections as set forth in this application, provide very high efficiency operation, and increased fuel efficiency.

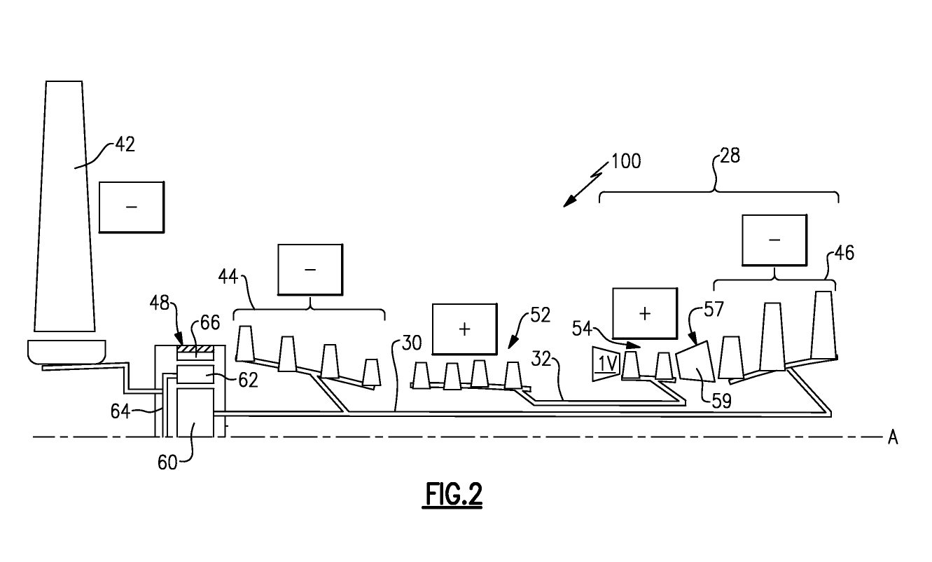

Referring to FIG. 2, with continued reference to FIG. 1, relative rotations between components of example disclosed engine architecture 100 are schematically shown. In the example engine architecture 100, the fan 42 is connected, through the gearbox 48, to the low spool 30 to which the low pressure compressor 44 and the low pressure turbine 46 are connected. The high pressure compressor 52 and the high pressure turbine 54 are connected to a common shaft forming the high spool 32. The high spool 32 rotates opposite the direction of rotation of the fan 42 (illustrated in FIG. 2 as the “+” direction.) The low spool 30 rotates in the same direction as the fan 42 (illustrated in FIG. 2 as the “−” direction.) The high pressure turbine 54 and the low pressure turbine 46, along with the mid-turbine frame 57 together forms the turbine section 28 of the gas turbine engine 20.

One disclosed example speed change device 48 has a gear reduction ratio exceeding 2.3:1, meaning that the low pressure turbine 46 turns at least 2.3 times faster than the fan 42. An example disclosed speed change device is an epicyclical gearbox of a planet type, where the input is to the center “sun” gear 60. Planet gears 62 (only one shown) around the sun gear 60 rotate and are spaced apart by a carrier 64 that rotates in a direction common to the sun gear 60. A ring gear 66, which is non-rotatably fixed to the engine static casing 36 (shown in FIG. 1), contains the entire gear assembly. The fan 42 is attached to and driven by the carrier 64 such that the direction of rotation of the fan 42 is the same as the direction of rotation of the carrier 64 that, in turn, is the same as the direction of rotation of the input sun gear 60. Accordingly, the low pressure compressor 44 and the low pressure turbine 46 counter-rotate relative to the high pressure compressor 52 and the high pressure turbine 54.

Counter rotating the low pressure compressor 44 and the low pressure turbine 46 relative to the high pressure compressor 52 and the high pressure turbine 54 provides certain efficient aerodynamic conditions in the turbine section 28 as the generated high speed exhaust gas flow moves from the high pressure turbine 54 to the low pressure turbine 46. Moreover, the mid-turbine frame 57 contributes to the overall compactness of the turbine section 28. Further, the airfoil 59 of the mid-turbine frame 57 surrounds internal bearing support structures and oil tubes that are cooled. The airfoil 59 also directs flow around the internal bearing support structures and oil tubes for streamlining the high speed exhaust gas flow. Additionally, the airfoil 59 directs flow exiting the high pressure turbine 54 to a proper angle desired to promote increased efficiency of the low pressure turbine 46.

Flow exiting the high pressure turbine 54 has a significant component of tangential swirl. The flow direction exiting the high pressure turbine 54 is set almost ideally for the blades in a first stage of the low pressure turbine 46 for a wide range of engine power settings. Thus, the aerodynamic turning function of the mid turbine frame 57 can be efficiently achieved without dramatic additional alignment of airflow exiting the high pressure turbine 54.

Referring to FIG. 3, the example turbine section 28 volume is schematically shown and includes first, second and third stages 46A, 46B and 46C. Each of the stages 46A, 46B and 46C includes a corresponding plurality of blades 212 and vanes 214. The example turbine section further includes an example air-turning vane 220 between the low and high turbines 54, 46 that has a modest camber to provide a small degree of redirection and achieve a desired flow angle relative to blades 212 of the first stage 46a of the low pressure turbine 46. The disclosed vane 220 could not efficiently perform the desired airflow function if the low and high pressure turbines 54, 46 rotated in a common direction.

The example mid-turbine frame 57 includes multiple air turning vanes 220 in a row that direct air flow exiting the high pressure turbine 54 and ensure that air is flowing in the proper direction and with the proper amount of swirl. Because the disclosed turbine section 28 is more compact than previously utilized turbine sections, air has less distance to travel between exiting the mid-turbine frame 57 and entering the low pressure turbine 46. The smaller axial travel distance results in a decrease in the amount of swirl lost by the airflow during the transition from the mid-turbine frame 57 to the low pressure turbine 46, and allows the vanes 220 of the mid-turbine frame 57 to function as inlet guide vanes of the low pressure turbine 46. The mid-turbine frame 57 also includes a strut 221 providing structural support to both the mid-turbine frame 57 and to the engine housing. In one example, the mid-turbine frame 57 is much more compact by encasing the strut 221 within the vane 220, thereby decreasing the length of the mid-turbine frame 57.

At a given fan tip speed and thrust level provided by a given fan size, the inclusion of the speed change device 48 (shown in FIGS. 1 and 2) provides a gear reduction ratio, and thus the speed of the low pressure turbine 46 and low pressure compressor 44 (shown in FIGS. 1 and 2) components may be increased. More specifically, for a given fan diameter and fan tip speed, increases in gear ratios provide for a faster turning turbine that, in turn, provides for an increasingly compact turbine and increased thrust to volume ratios of the turbine section 28. By increasing the gear reduction ratio, the speed at which the low pressure compressor 44 and the low pressure turbine 46 turn, relative to the speed of the fan 42, is increased.

Increases in rotational speeds of the gas turbine engine 20 components increases overall efficiency, thereby providing for reductions in the diameter and the number of stages of the low pressure compressor 44 and the low pressure turbine 46 that would otherwise be required to maintain desired flow characteristics of the air flowing through the core flow path C. The axial length of each of the low pressure compressor 44 and the low pressure turbine 46 can therefore be further reduced due to efficiencies gained from increased speed provided by an increased gear ratio. Moreover, the reduction in the diameter and the stage count of the turbine section 28 increases the compactness and provides for an overall decrease in required axial length of the example gas turbine engine 20.

In order to further improve the thrust density of the gas turbine engine 20, the example turbine section 28 (including the high pressure turbine 54, the mid-turbine frame 57, and the low pressure turbine 46) is made more compact than traditional turbine engine designs, thereby decreasing the length of the turbine section 28 and the overall length of the gas turbine engine 20.

In order to make the example low pressure turbine 46 compact, make the diameter of the low pressure turbine 46 more compatible with the high pressure turbine 54, and thereby make the air-turning vane 220 of the mid-turbine frame 57 practical, stronger materials in the initial stages of the low pressure turbine 46 may be required. The speeds and centrifugal pull generated at the compact diameter of the low pressure turbine 46 pose a challenge to materials used in prior art low pressure turbines.

Examples of materials and processes within the contemplation of this disclosure for the air-turning vane 220, the low pressure turbine blades 212, and the vanes 214 include materials with directionally solidified grains to provided added strength in a span-wise direction. An example method for creating a vane 220, 214 or turbine blade 212 having directionally solidified grains can be found in U.S. application Ser. No. 13/290,667, and U.S. Pat. Nos. 7,338,259 and 7,871,247, each of which is incorporated by reference. A further, engine embodiment utilizes a cast, hollow blade 212 or vane 214 with cooling air introduced at the leading edge of the blade/vane and a trailing edge discharge of the cooling air. Another embodiment uses an internally cooled blade 212 or vane 214 with film cooling holes. An additional engine embodiment utilizes an aluminum lithium material for construction of a portion of the low pressure turbine 46. The example low pressure turbine 46 may also be constructed utilizing at a powdered metal disc or rotor.

Additionally, one or more rows of turbine blades 212 of the low pressure turbine 46 can be constructed using a single crystal blade material. Single crystal constructions oxidize at higher temperatures as compared to non-single crystal constructions and thus can withstand higher temperature airflow. Higher temperature capability of the turbine blades 212 provide for a more efficient low pressure turbine 46 that may be further reduced in size.

While the illustrated low pressure turbine 46 includes three turbine stages 46a, 46b, and 46c, the low pressure turbine 46 can be modified to include up to six turbine stages. Increasing the number of low pressure turbine stages 46a, 46b, 46c at constant thrust slightly reduces the thrust density of the turbine section 28 but also increases power available to drive the low pressure compressor and the fan section 22.

Further, the example turbine blades may be internally cooled to allow the material to retain a desired strength at higher temperatures and thereby perform as desired in view of the increased centrifugal force generated by the compact configuration while also withstanding the higher temperatures created by adding low pressure compressor 46 stages and increasing fan tip diameter.

Each of the disclosed embodiments enables the low pressure turbine 46 to be more compact and efficient, while also improving radial alignment to the high pressure turbine 54. Improved radial alignment between the low and high pressure turbines 54, 46 increases efficiencies that can offset any increases in manufacturing costs incurred by including the air turning vane 220 of the mid-turbine frame 57.

In light of the foregoing embodiments, the overall size of the turbine section 28 has been greatly reduced, thereby enhancing the engine's power density. Further, as a result of the improvement in power density, the engine's overall propulsive efficiency has been improved.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the invention may be practiced other than as specifically described. For that reason the appended claims should be studied to determine true scope and content.

1. A gas turbine engine comprising:
a fan rotatable about an axis;
a compressor section having a low pressure compressor section and a high pressure compressor section;
a combustor in fluid communication with the compressor section;
a turbine section in fluid communication with the combustor, said turbine section having a low pressure turbine section and a high pressure turbine section; and
a speed change system driven by the turbine section,
wherein said fan is disposed axially forward of the speed change system and is driven in a first direction by the turbine section through the speed change system,
wherein said low pressure compressor section and said low pressure turbine section rotate about said axis in the first direction, and
wherein said high pressure compressor section and said high pressure turbine section rotate about said axis in a second direction opposite said first direction.

2. The gas turbine engine of claim 1, including a power density of greater than about 1.5 lbf/in³ and less than or equal to about 5.5 lbf/in³.

3. The turbine engine of claim 1, wherein said speed change system comprises a geared architecture.

4. The turbine engine of claim 3, wherein said geared architecture is a planetary geared architecture.

5. The turbine engine of claim 4, wherein said planetary geared architecture includes a sun gear driven by the turbine section, a plurality of planetary gears driven by the sun gear, a carrier supporting each of the plurality of planetary gears and a ring gear, and wherein the fan is attached to the carrier for rotation in the first direction.

6. The turbine engine of claim 5, wherein the low pressure turbine section drives a first shaft, which drives the sun gear.

7. The turbine engine of claim 1, including a mid-turbine frame between said low pressure turbine section and said high pressure turbine section, wherein said mid-turbine frame comprises a fixed vane.

8. The turbine engine of claim 7, wherein said fixed vane of said mid-turbine frame comprises a plurality of airfoils operable to direct airflow entering said low pressure turbine section.

9. The turbine engine of claim 8, wherein the mid-turbine frame includes a strut for supporting a bearing supporting rotation of a portion of the turbine section.

10. The turbine engine of claim 7, wherein said fixed vane comprises an inlet vane for the low pressure turbine section.

11. The turbine engine of claim 1, wherein said high pressure turbine section includes two stages.

12. The turbine engine of claim 1, wherein said high pressure turbine section includes a single stage.

13. The turbine engine of claim 1, wherein said low pressure turbine section includes at least one powdered metal disc.

14. The turbine engine of claim 1, wherein said low pressure turbine section includes at least one stage comprising single crystal turbine blades.

15. The turbine engine of claim 1, wherein said low pressure turbine section includes at least one stage comprising directionally solidified turbine blades.

16. The turbine engine of claim 1, wherein said low pressure turbine section is at least partially constructed of an aluminum lithium material.

17. A method for increasing a power density of a gas turbine engine comprising the step of:
rotating a low pressure turbine section and a low pressure compressor section in a first direction;
rotating a high pressure turbine section and a high pressure compressor section in a second direction opposite the first direction; and
driving a fan disposed forward of a speed change system and driven through the speed change system in the first direction such that the low pressure turbine section and low pressure compressor section rotate at a speed greater than the fan.

18. The method of claim 17, further comprising the step of reducing a volume of the low pressure turbine section by directing high speed gas flow entering said low pressure turbine section with a mid-turbine frame vane.

19. The method of claim 18, including housing a mid-turbine frame strut within said mid-turbine frame vane.

20. The method of claim 17, including generating a power density that is greater than or equal to about 1.5 lbf/in³ and less than or equal to about 5.5 lbf/in³.

21. A gas turbine engine comprising:
a fan rotatable about an axis;
a compressor section having a low pressure compressor section and a high pressure compressor section;
a combustor in fluid communication with the compressor section;
a turbine section in fluid communication with the combustor, the turbine section having a low pressure turbine section and a high pressure turbine section, the turbine section defining a volume and producing a thrust with a ratio of thrust expressed in pounds force related to the turbine section volume within a range greater than or equal to about 1.5 lbf/in³ and less than or equal to about 5.5 lbf/in³; and
a speed change system driven by the turbine section,
wherein said fan is driven in a first direction by the turbine section through the speed change system,
wherein said low pressure compressor section and said low pressure turbine section rotate about said axis in the first direction, and
wherein said high pressure compressor section and said high pressure turbine section rotate about said axis in a second direction opposite said first direction.

22. The gas turbine engine as recited in claim 21, including a mid-turbine frame disposed between the high pressure turbine and the low pressure turbine.

23. The gas turbine engine as recited in claim 21, wherein the speed change system comprises a geared architecture including a sun gear driven by the low pressure turbine section, a plurality of planetary gears driven by the sun gear, a carrier supporting each of the plurality of planetary gears and a ring gear, and wherein the fan is attached to the carrier for rotation in the first direction common with the low pressure turbine.
